(19) United States
(12) Patent Application Publication
(10) Pub. No.: US 2016/0004859 A1
(43) Pub. Date: Jan. 7, 2016

(54) METHOD AND SYSTEM FOR PLATFORM AND USER APPLICATION SECURITY ON A DEVICE

(71) Applicant: Irdeto Canada Corporation, Ottawa (CA)

(72) Inventors: Grant Goodes, Manotick (CA); Marcus Leech, Smith Falls (CA)

(21) Appl. No.: 14/431,298

(22) PCT Filed: Mar. 26, 2013
(86) PCT No.: PCT/CA2013/000288

§ 371 Date: Mar. 25, 2015

(51) Int. Cl. G06F 21/44; G06F 21/60

(52) U.S. Cl. CPC G06F 21/44; G06F 21/604

(57) ABSTRACT

A method and system for platform and user application security on a computing device is provided. The method includes: verifying integrity of operating system code on the computing device to establish a trusted execution environment in the operating system of the computing device; and in response to success of the integrity verification of the operating system code, binding a user-space application on the computing device to the operating system on the computing device.

### FIELD OF INVENTION

The present invention relates to a computer system and method, and more specifically to a system and method for platform and user application security on a computing device.

### BACKGROUND OF THE INVENTION

Protecting user-space code on computing devices such as mobile phones has been increasingly important. There currently exist several approaches for security of application code on such devices: One of these is Discretionary Access Controls (DAC). Conventionally operating systems (OS's) utilize DACs to restrict access to objects based on User-IDs, thereby protecting the objects from unauthorized access. The owners of the objects under DAC have the ability to make policy decisions and/or assign security attributes. Using DAC, it is possible to permit or deny other users permission to, for example, execute certain user application code. However, the fundamental limitation of the DAC approach is that there is a “root” user which is exempt from the limitations imposed by DAC on all other User-IDs, and thus a malicious user may completely bypass DAC by simply acquiring root privilege (also known as “rooting the device”).

SE Linux is another approach to securing a Linux platform by imposing Mandatory Access Controls (MACs), which as the name suggests are not discretionary based on the User-ID. The SE Linux approach provides for a policy-based security mechanism in which every potentially privileged access to files, drivers, and other system resources, is granted or denied based on not just the User-ID, but the executing process making the request. The fundamental difficulty with SE Linux (and the reason it is not more widely employed) is that the security policy data is very complex (almost arbitrarily so), in that it must describe the complete matrix of every resource on the system and every process that may or may not be allowed access to those resources. Furthermore, it is required to update the policy every time new software is installed in a device. This is virtually unmanageable in practice and has largely prevented real-world adoption of SE Linux.

Therefore, there is a need to provide a new system and method for improving security on a computing device.

### SUMMARY OF THE INVENTION

It is an object of the invention to provide a method and system that obviates or mitigates at least one of the disadvantages of existing systems.

In accordance with an aspect of the present disclosure, there is provided a method of enhancing security on a computing device, which includes: verifying integrity of operating system code on the computing device to establish a trusted execution environment in the operating system of the computing device; and in response to the successful integrity verification of the operating system code, binding a user-space application on the computing device to the operating system on the computing device.

In accordance with a further aspect of the present disclosure, there is provided a computer readable storage medium storing one or more programs, the one or more programs comprising instructions, which when executed by a computer processer in a computing device, cause the processor to perform the method enhancing security on a computing device.

In accordance with a further aspect of the present disclosure, there is provided a system for enhancing security on a computing device, which includes: a processor configured for: verifying integrity of operating system code on the computing device to establish a trusted execution environment in the operating system of the computing device; and in response to the successful integrity verification of the operating system code, binding a user-space application on the computing device to the operating system on the computing device.

### BRIEF DESCRIPTION OF THE DRAWINGS

These and other features of the invention will become more apparent from the following description in which reference is made to the appended drawings wherein:

FIGS. 1A-1H are flow diagrams illustrating examples of enhancing security on a computing device;

FIGS. 2A-2D are schematic diagrams illustrating an exemplary building and provisioning process for a secure platform;

FIG. 3A is a schematic diagram illustrating one example of a System Startup process in the secure platform including creation of a kernel and a Kernel Agent;

FIG. 3B is another schematic diagram illustrating the System Startup process including establishment of a Trusted Execution Environment (TEE) in a kernel-space;

FIG. 4A is a schematic diagram illustrating one example of a User Application Startup process in the secure platform including creation of a user application process;

FIG. 4B is another schematic diagram illustrating the User Application Startup process including integrity verification of the user application process;

FIG. 4C is a further schematic diagram illustrating the User Application Startup process including binding the user application process to kernel-space; and

FIG. 5 is a schematic diagram illustrating one example of a mobile device with an open source OS to which the User Startup process shown in FIGS. 3A and 3B and the User Application Startup process shown in FIGS. 4A˜4C may be implemented.

For simplicity and clarity of the illustration, elements in the figures are not necessarily to scale, are only schematic and are non-limiting, well known components may be omitted, and the same reference numbers in different figures denote the same elements, unless stated otherwise.

In the description below, the terms “device(s)”, “platform(s)” and “system(s)” may be used interchangeably, and the terms “executable”, “process”, “module” and “component” may be used interchangeably. In the description below, the terms “kernel (executable) process”, “kernel (executable) module”, and “kernel” may be used interchangeably. In the description below, the terms “Kernel Agent (executable) process”, “Kernel Agent module”, and “Kernel Agent” may be used interchangeably.

### DETAILED DESCRIPTION

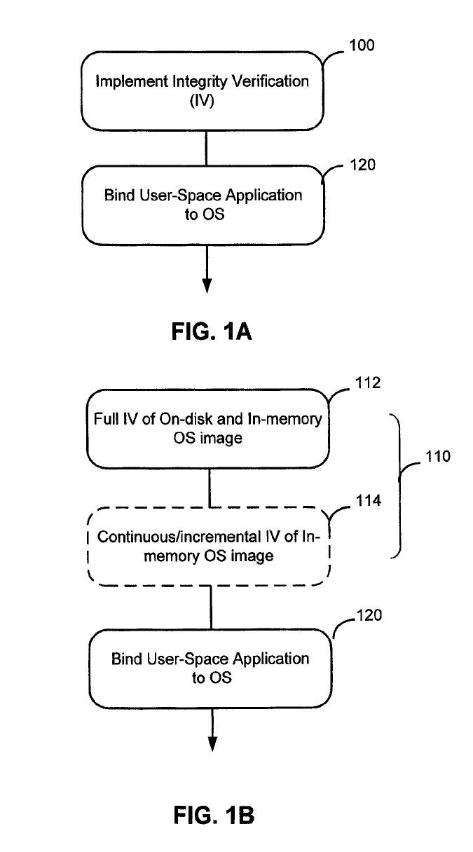

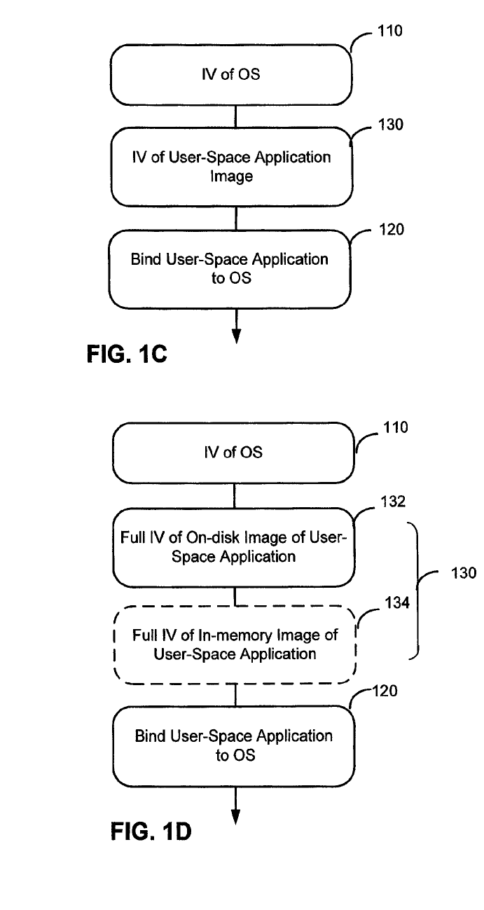

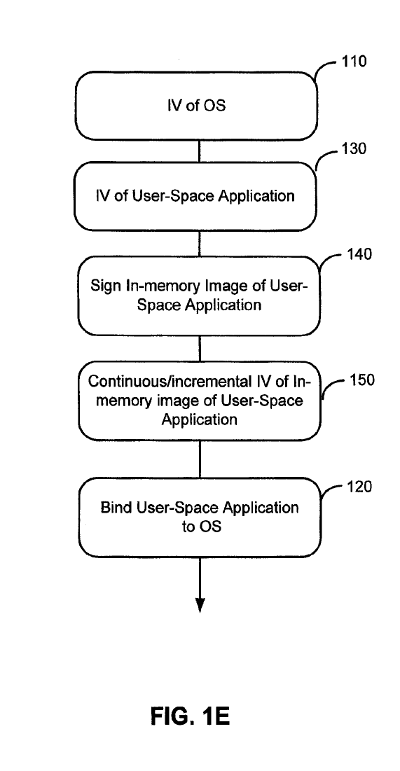

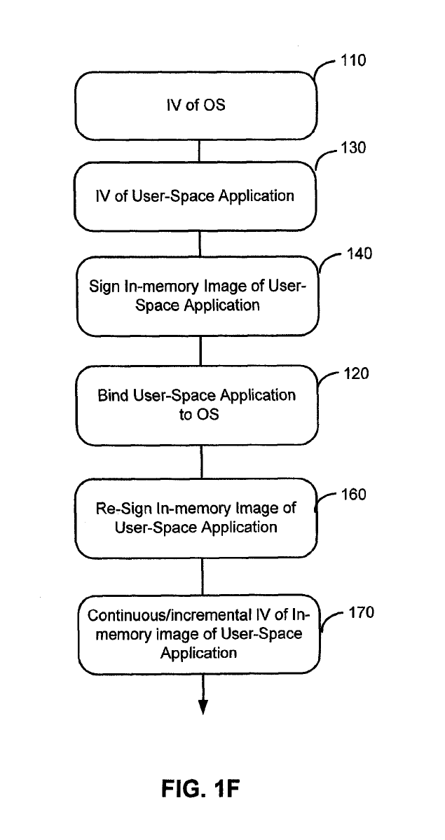

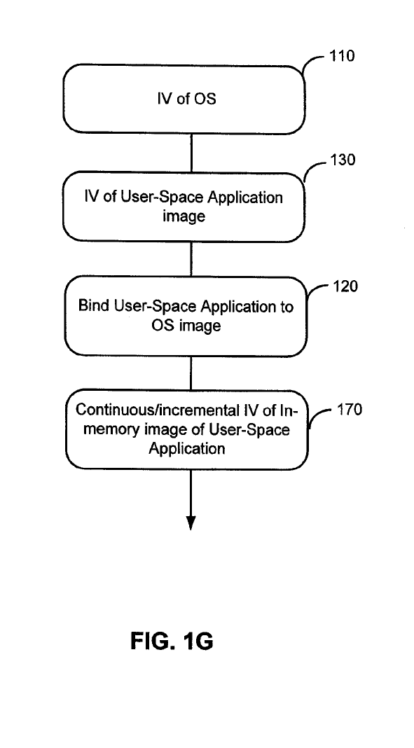

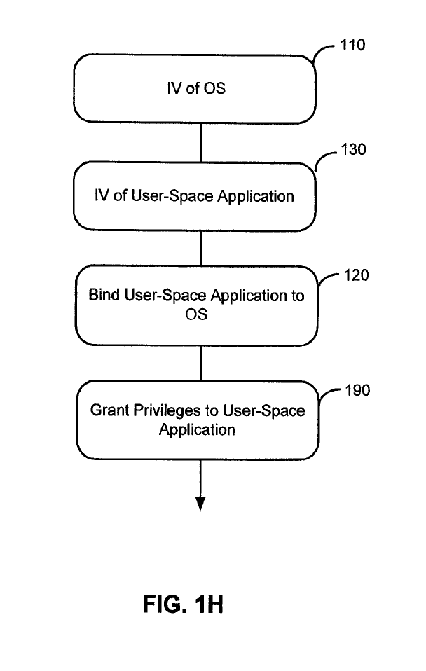

Embodiments are described below, by way of example only, with reference to FIGS. 1-5.

In the present disclosure, a secure platform and method for enhancing security on a computing device is provided. The secure platform and method for enhancing security on a computing device is applicable to, for example, but not limited to, any computing devices including mobile phones, games consoles, tablets, set top boxes, televisions or other consumer electronic devices. The embodiments of the present disclosure are described, by way of example only, in terms of any platforms that use an open source operating system (OS), for example, but not limited to, Linux or Android™ OS and these examples should not be construed as limiting the intended scope of the present invention.

Referring to FIGS. 1A-1H, there are illustrated examples of a process for enhancing security on a computing device, at runtime. The process includes verifying (100) integrity of code on the computing device to establish a Software (SW) TEE in the computing device, and in response to the result of the integrity verification (“IV”), binding (120) a user-space application on the computing device to the OS of the computing device. The IV of code includes either one or more of IV of the OS (110) and IV of the user-space application (130).

In a non-limiting example, the IV (100) step includes the IV (110) of the OS code to verify that the computing device has a trusted OS to establish a SW TEE in the OS space. If the IV (110) of the OS code is successful, it is determined that the OS of the computing device is fully trusted. In a non-limiting example, upon success of the IV (110) of the OS, the binding (120) step is implemented. In a non-limiting example, the IV (110) of the OS includes either one or more of IV of the on-disk image of the OS, IV of the in-memory image of the OS, and continuous/incremental IV of the in-memory image of the OS. In a non-limiting example, upon success of IV (112) of the on-disk and in-memory image of the OS, the binding (120) step is implemented. In a non-limiting example, upon success of the IV (112) of the on-disk and in-memory image of the OS, continuous/incremental IV (114) of the in-memory image of the OS is implemented (see FIG. 1B). If the continuous/incremental IV (114) of the in-memory image of the OS is successful, the binding (120) step is implemented.

In a non-limiting example, the IV (100) step includes IV (130) of the user-space application to verify that the computing device has a SW TEE in user-space (see e.g., FIGS. 1C-1H). If the IV (130) of the user-space application is successful, it is determined that the user-space of the computing device is fully trusted. In a non-limiting example, if the full IV (110) of the OS image is successful, the IV (130) of the user-space application is implemented, which establishes a SW TEE in the OS-space and the user-space. In a non-limiting example, the IV (130) of the user-space application includes either one or more of IV (132) of the on-disk image of the user-space application, IV (134) of the in-memory image of the user-space application, and continuous/incremental IV (150, 170) of the in-memory image of the user-space application. Either one of more of these IVs may be implemented subsequently. In a non-limiting example, upon success of the full IV (132) of the on-disk image of the user-space application image, the binding (120) step is implemented. In a non-limiting example, upon success of the full IV (132) of the on-disk image of the user-space application, the full IV (134) of the in-memory image of the user-space application is implemented. In a non-limiting example, the full IV (134) of the in-memory image of the user-space application is implemented by skipping relocations (e.g., relocations of a loader for loading contents of the on-disk user application). In a non-limiting example, upon success of the full IV of the on-disk and in-memory image of the user-space application, the binding (120) step is implemented.

In a non-limiting example, the in-memory image of the user-space application (including the relocations) is signed (140) after the IV (130) of the user-space application image (see e.g., FIGS. 1E-1G). In a non-limiting example, after signing (140) the in-memory image of the user-space application, continuous/incremental IV (150) of the in-memory image of the user-space application is implemented based on the full signature (associating with the signing (140) step). In a non-limiting example, upon success of the continuous/incremental IV (150) of the in-memory image of the user-space application, the binding (120) step is implemented (see e.g., FIG. 1E). In a non-limiting example, after signing (140) the in-memory image of the user-space application, the binding (120) step is implemented, and then the in-memory user-space application image is re-signed (160) since it may have changed due to the binding (120) step's result. In a non-limiting example, after re-signing (160) the in-memory user-space application image, continuous/incremental IV (170) of the in-memory application image is implemented based on the full signature (associating with the re-signing (160) step) (see FIG. 1F). In a non-limiting example, after the binding (120) step, continuous/incremental IV (170) of the in-memory application image is implemented as the binding (120) step may change the user-application image (see FIG. 1G).

In a non-limiting example, the binding (120) step includes restoring a missing piece of code and/or data (or “MP”) to the user-space application. In a non-limiting example, the MP is revoked if any IV fails. In a non-limiting example, after the binding (120) step, continuous/incremental IV (170) of the in-memory image of the use application is implemented (see e.g., FIG. 1G), and then upon failure of any IV, the binding (or MP) is removed.

In a non-limiting example, if all performed IV is successful, the system grants (190) privileges to the user application (e.g., privileged access to the computing device's resource(s)) (see FIG. 1H). The system may grant (190) privileges to the user application as a result of binding (120) the user application to the OS. If any IV fails, the privilege(s) will be revoked.

In a non-limiting example, the OS of the computing device is a kernel based OA, and the IV of the OS (110) includes the IV of the kernel-space during system startup to create the trusted OS kernel-space. The IV of the kernel image may be performed by a Kernel Agent of the kernel based OS. The IV of the kernel image may include either one or more of IV of the on-disk image of the kernel, IV of the in-memory image of the kernel, the on-disk image of the Kernel Agent, IV of the in-memory image of the Kernel Agent,

In a non-limiting example, the IV steps of FIGS. 1A-1G, the binding step 120, the signing step (140), the re-signing step (160), and/or granting step (190) are implemented by the Kernel Agent of the kernel based OS. In a non-limiting example, contents are relocated in a Virtual Memory Area(s) (VMA(s)) allocated to the user application process. In a non-limiting example, the contents relocated in the VMAs may be re-signed (160) for future IV verification after the binding step (120), as some forms of binding actually change the contents of the VMAs themselves.

In a non-limiting example, the security of the platform with the OS is enhanced by a Mandatory Access Control (MAC) mechanism. The MAC constrains the ability of a user to execute application code or access system resources regardless of whether the user is “root”, or masquerades as “root”. The Kernel Agent in the trusted OS kernel-space monitors and intercepts specific system-calls from user-space into the kernel. The Kernel Agent is thus able to monitor creation of user-space processes (aka “invoking an application”) on an ongoing basis and apply Process State Verification to validate callers. The term “Process State Verification” refers to the process of ensuring that the entire executable memory of the calling process is fully signed/validated code, thereby preventing common code-injection attacks such as over-writing code-space or shared-library shimming. The Kernel Agent validates the executable image (either one or more of on-disk and in-memory), generates a verifiable signature of the entire process-space executable memory, and binds the user-space application to the trusted kernel-space. In this way, the KA is used to establish a Software (SW) TEE in the kernel-space and extend that SW TEE into user-space (at least for designated user-space applications of interest).

In a non-limiting example, the Process State Validation is implemented based on the signature and validation (e.g., IVs in FIGS. 1A-1H), ensuring that no executable code can be modified from the contents of the original signed executable. Furthermore, the injection of unsigned code (for example via shared-library shimming) is prevented, since the Kernel Agent mediates the loading of all code (including shared-libraries).

In a non-limiting example, the Kernel Agent of the kernel based OS binds the user-space code to the trusted kernel-space code by using a Missing Piece (“MP”) technique. Binding the user-space application to the kernel-based OS prevents a malicious attacker from simply taking the executable code from the on-disk user application file and running it in on another device. This MP-based binding technique also prevents an attacker from turning off some of the protections of the user application.

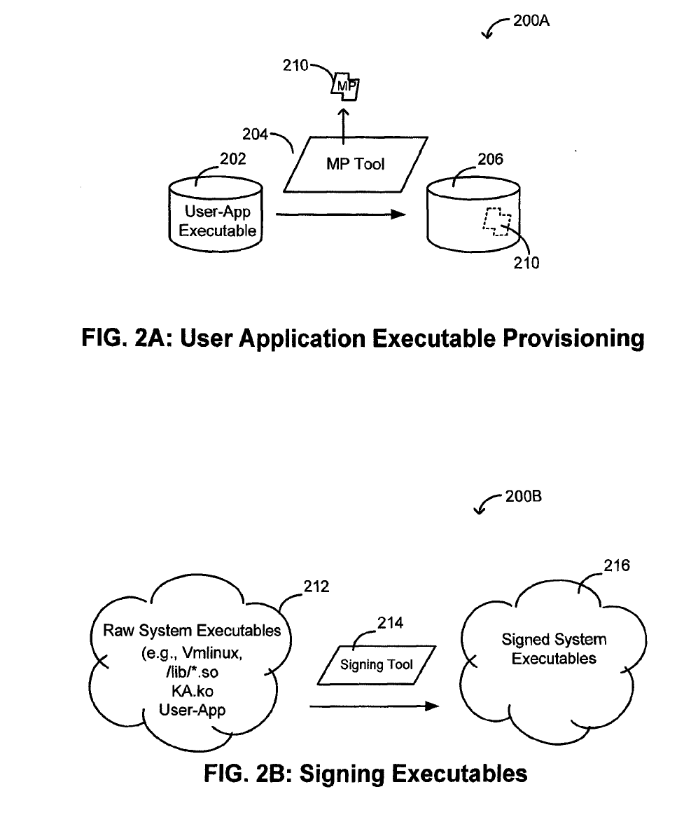

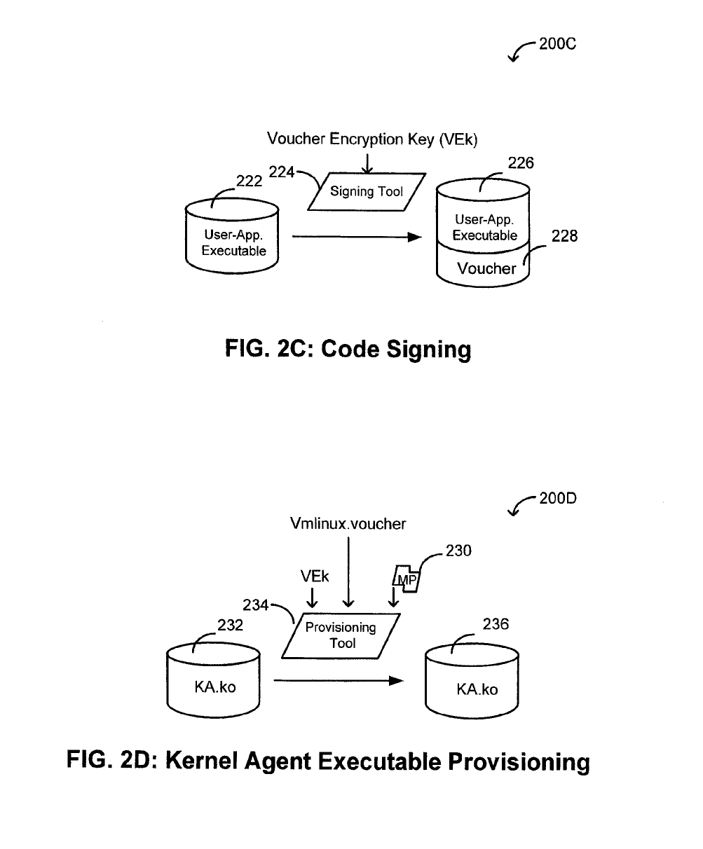

Referring to FIGS. 2A-2D, there is illustrated an example of a process for building and provisioning preparation for utilizing the secure platform on a computing device with a kernel based OS. The building and provisioning preparation process includes provisioning and signing system executables. In a non-liming example, the provisioning process includes user application executable provisioning 200A and Kernel Agent Executable provisioning 200D. In a non-limiting example, the signing system executables 200B process includes code signing 200C of the user application executable.

User Application Executable Provisioning 200A (FIG. 2A): A piece of code and/or data 210 (“MP” in FIG. 2A) in an original user application executable file 202 (“User-App. Executable” in FIG. 2A) is used for provisioning the user application file 202. The piece of code and/or data 210 may include, for example, but not limited to, an encryption key(s), other credential value(s), a secret and/or Whitebox Table Data disclosed, for example, in United States Patent Application Publication Nos. 2010/0296649, 2011/0150213 and 2011/0235803, which are incorporated herein by reference.

In a non-limiting example, the piece of code and/or data 210 is extracted from the original user application file 202 by using a provisioning tool 204 and replaced by dummy values. The resultant user application executable image (file) 206 contains the original version of the user application code and/or data except for the piece of code and/or data 210. At runtime the Kernel Agent (e.g., “KA.ko” in 212 of FIG. 2B, 236 of FIG. 2D) will inject this missing piece of code and/or data 210 into the user-space process's executable memory to restore the piece of code and/or data 210 of the original user application file 202.

In a further non-limiting example, the piece of code and/or data 210 in the user application file 202 is corrupted or encrypted by the provisioning tool 204. At runtime the Kernel Agent (e.g.,“KA.ko” in 212 of FIG. 2B, 236 of FIG. 2D) will uncorrupt or decrypt the corrupted or encrypted piece of code and/or data and inject the resultant piece of code and/or data into the user-space process's executable memory to restore the missing original piece of code and/or data 210.

Signing Executables 200B (FIG. 2B): in order to authenticate and protect system executables 212, a signing tool 214 digitally signs the executables 212 and creates signed executables 216. In a non-limiting example, the system executables 212 include an executable file containing a kernel image (e.g., Vmlinux), the Kernel Agent executable file (“KA.ko”), a number of shared-libraries (also known as dynamically linked libraries) designated, “/lib/*.so”, and a user application (“User App.”) executable file. The signed executables 216 prevent attackers from replacing the signed executables with versions of unsigned executables and serve to explicitly identify executable code that is to be considered privileged and/or protected by the Kernel Agent.

In a non-limiting example, the user application executable is signed at 200B after the user application executable provisioning 200A. In a further non-limiting example, the user application executable may be signed at 200B before the user application executable provisioning 200A in the case that the extraction of the piece of code and/or data 210 does not change the user application executable to be signed.

Code Signing 200C (FIG. 2C): In a non-limiting example, a user application executable file 222 (“User-App. Executable” in FIG. 2C) is signed by a signing tool 224. A voucher 228 expressing the rights of the code contents is created by the signing tool 224. The voucher 228 is protected against inspection/modification by being encrypted using a Voucher Encryption key (“VEk”). The voucher 228 is attached to the signed user application executable file 226. This voucher 228 is used to validate the user code at runtime. A third party (e.g., a trusted publisher of the file 202) may further sign the user application.

The provisioning of the user application executable 200A and the code signing 200C may be independently implemented, depending on the MP technique. For example, if the piece of data 210 is extracted from the user application file 202, the code signing 200C is implemented independent of the user application provisioning 200A. If the piece of code 210 in the user application file 202 is changed by the provisioning tool 204, it changes the contents of the executable file (and thus, the computed signature), and the code signing 200C is, therefore, be implemented after the user application provisioning 200A.

Kernel Agent Executable Provisioning 200D (FIG. 2D): In a non-limiting example, the Kernel Agent executable file 232 is configured by using a provisioning tool 234 taking as input the Voucher Encryption key VEk, Vmlinux.voucher, and Missing Piece code and/or data 230 associated with the code and/or data 210 used for provisioning (200A) the user application executable so that the resultant Kernel Agent 236 can restore the original user application functionality by supplying the missing code and/or data 210. The code and/or data 230 may be the piece of code and/or data 210 in the original user application file 202 or a piece of code and/or data for restoring the piece of code and/or data 210. In a non-limiting example, the Kernel Agent executable file 236 is signed at 200B.

At runtime, in response to a call to create a user application executable image in memory, the Kernel Agent implements IV of the user application file (on-disk) with the voucher (e.g., 228 of FIG. 2C), implements IV of the associated user application process in memory, and restores the piece of code and/or data 210 of the original user application file, in the user application process's executable memory.

The Kernel Agent is configured to, among other things, implement “IV” of code or data images in the system, including, for example, static or on-disk Integrity Verification (e.g., on HDD or on flash memory) and dynamic or in-memory Integrity Verification (e.g., in random access memory (RAM)). The Kernel Agent is configured to, among other things, act as a watcher to dynamically monitor the integrity of the kernel components, the secure boot components, all protected applications and their associated shared-libraries.

The IV is implemented, for example, but not limited to, by computing a signature (e.g. a hash value) for an object (e.g., a system component, an application) and then comparing that to a known good value for the signature. If the calculated value is the same as the stored known good value, the Kernel Agent assumes that the object has not been modified by an attacker. However, if the calculated value is different than the stored known good value, the Kernel Agent assumes that the object has been modified and can no longer be trusted to perform the functionality that it was intended to perform or that it does not have the same privileges that were originally assigned to the object.

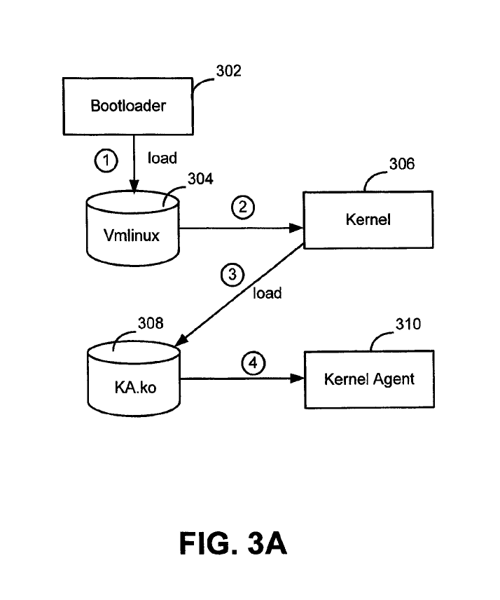

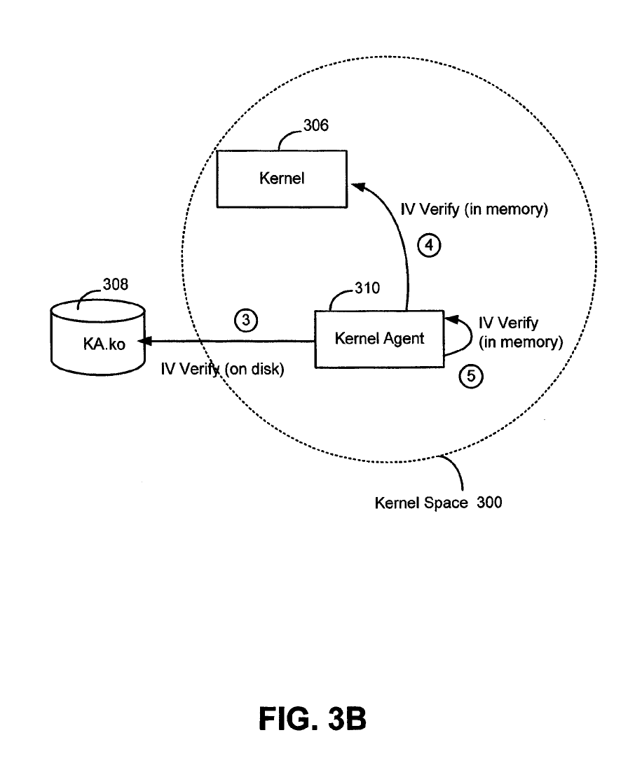

Referring to FIGS. 3A and 3B, there is illustrated one example of a System Startup process in the secure platform. In the System Startup process, a kernel-space 300 in the platform is initialized so that any unsigned kernel code, or signed kernel code that does not pass IV verification, is not permitted to be loaded, which establishes a Software TEE in the kernel-space 300.

The System Startup process includes, among others, executing an OS boot-loading process 302 (“Bootloader” in FIG. 3A), which will load and boot the operating system. By using the boot loader 302, a system executable file including an executable kernel 304 is loaded (step 1 of FIG. 3A). The kernel executable file 304 is found in, for example, but not limited to, a Vmlinux image file. Upon the kernel file 304 being loaded, the kernel executable process 306 is created in memory (step 2 of FIG. 3A). The kernel process 306 is executed to load a Kernel Agent executable image (file) 308 (step 3 of FIG. 3A). The Kernel Agent executable process 310 is created (step 4 of FIG. 3A) in memory by loading the Kernel Agent executable file 308.

For example, the Kernel Agent file 308 corresponds to the Kernel Agent file 236 of FIG. 2D to which Missing Piece code and/or data 230 of FIG.2D has been attached.

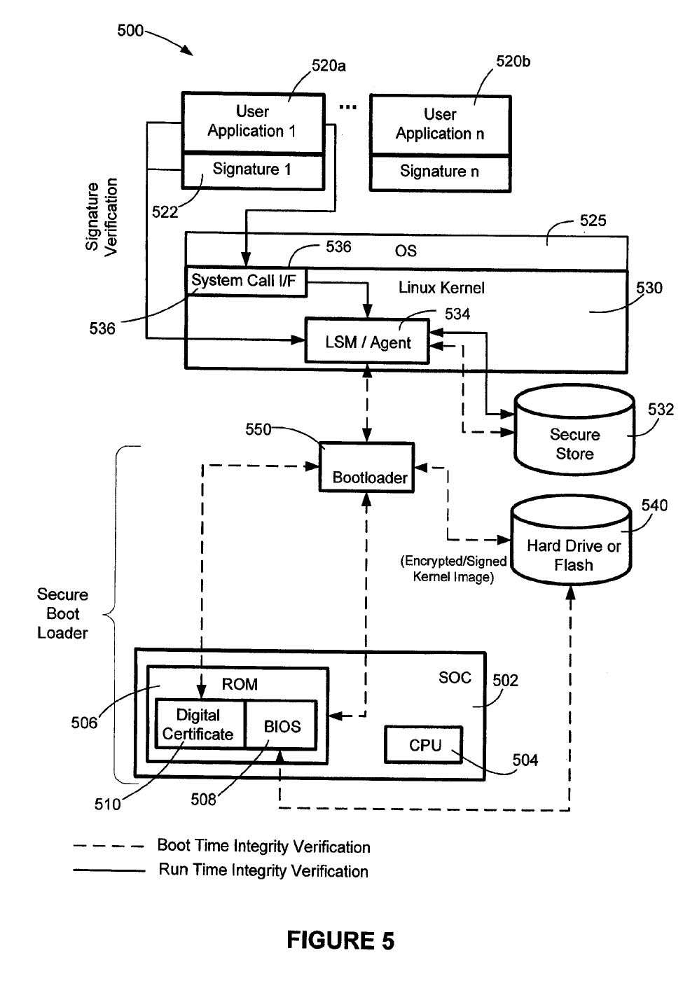

The Kernel Agent 310 gains execution control during initialization to perform IV operations in the kernel-space 300. In a non-limiting example, the Kernel Agent 310 implements IV operations, including: (1) in-memory IV to verify integrity of the kernel image itself 306 (step 3 in FIG. 3B); (2) on-disk IV to verify integrity of the Kernel Agent executable file 308 (step 4 in FIG. 3B); and (3) in-memory IV to verify the integrity of the Kernel Agent 310 executable image itself (step 5 in FIG. 3B). The integrity of all these components is confirmed by the Kernel Agent module 310, for example, by using comparisons to data in a Kernel Agent secure store (e.g., 532 of FIG. 5) allocated to the Kernel Agent 310.

In addition, the Kernel Agent 310 is executed to perform all in-memory IV upon the kernel executable image and the Kernel Agent executable image incrementally, which will detect dynamic attacks.

By completing the IV operations, the Kernel Agent 310 confirms that the OS installed in the platform is the intended OS such that the kernel 306 has not been modified between boot-load and the bring-up of the Kernel Agent 310 and the Kernel Agent 310 performs the functionality that it was intended to perform. The kernel-space 300 is fully verified and trusted, and thus the kernel code and Kernel Agent code run in a fully secured fashion. If the Kernel Agent 310 detects itself running in an un-trusted environment, it will take an appropriate action, such as shutting itself down, and removing any privileged assets (or resources, e.g., OS, hardware components, network components) which have been distributed to user applications.

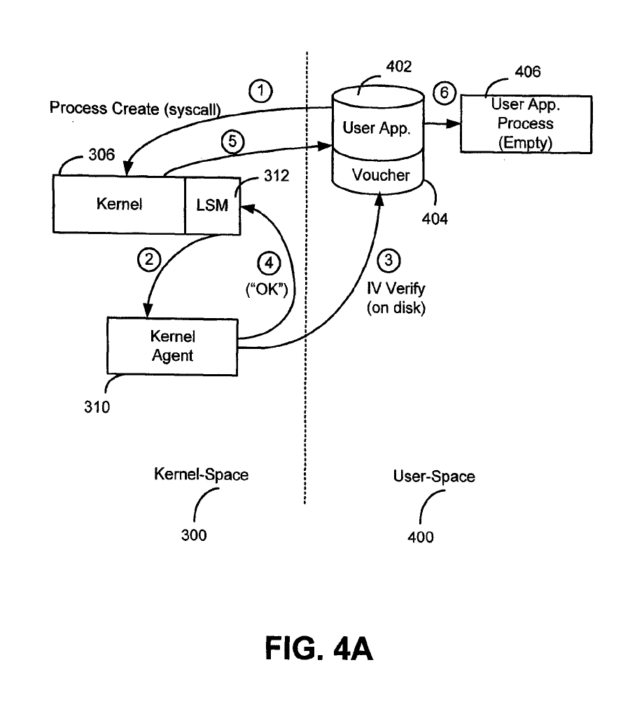

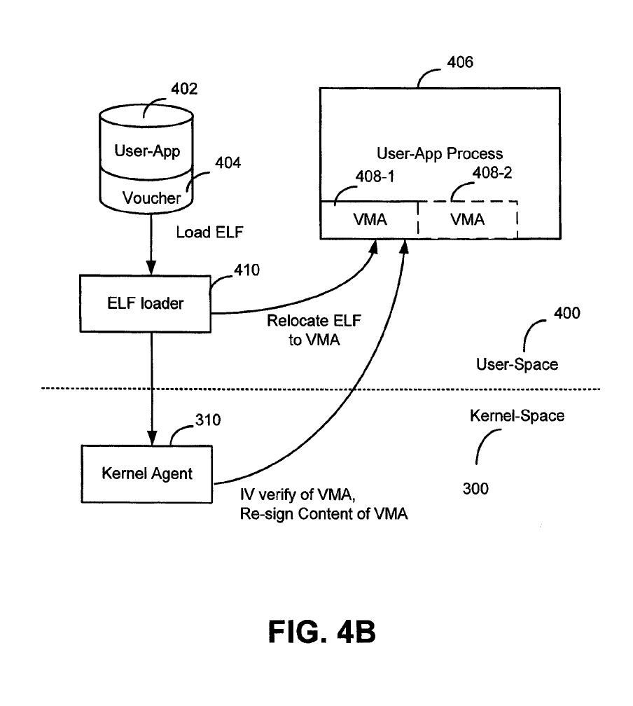

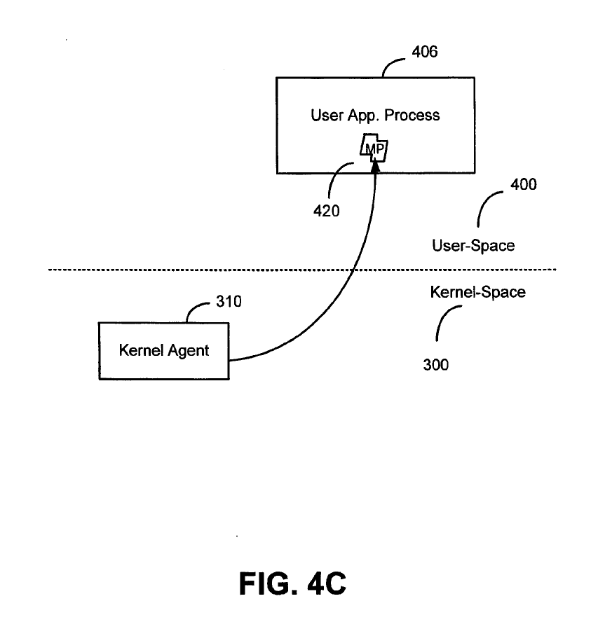

Referring to FIGS.4A˜4C, there is illustrated one example of a User Application Startup process in the secure platform. Once the Kernel Agent 310 completes the System Startup process of FIGS. 3A and 3B, the platform is ready for the User Application Startup process and the Kernel Agent 310 monitors a system call to create a user-space process. At this point, the kernel-space 300 provides a fully trusted environment.

A system call (“Process Create” in FIG. 4A) to create a user application process from the user application executable 402 is intercepted in the kernel 306 (step 1 of FIG. 4A). In response to the process create system call, Linux Security Module (LSM) 312 provides a hook (step 2 of FIG. 4A) in the Kernel Agent 310.

The user application file 402 contains, for example, a user application executable file signed in the code signing process 200C as shown in FIG. 2C and missing the piece of code and/or data 210 of FIG. 2A.

The Kernel Agent 310 then implements on-disk IV of the user application file 402 (step 3 of FIG. 4A) by using the embedded voucher 404 (e.g. 228 of FIG. 2C). If the IV verification of the user application fails, or if the voucher is not encrypted with the correct Voucher Encryption key (e.g., VEk of FIGS. 2C and 2D), or if there is no voucher present at all, the user application file may still be permitted to load, but it will not be granted any privileges. In this way, tampered application code is treated the same way as completely unsigned code, and “normal” operation of the device (where the user is free to install arbitrary software) will be preserved. Alternatively, the Kernel Agent 310 may take a more restricted approach to device security and refuse to load signed but tampered code, or even more restricted, refuse to load unsigned code. This final approach could be called a Whitelist approach, in that only signed code (“on the whitelist”) would be allowed to run.

The IV may be conducted by, for example, but not limited, comparing the signature in the voucher 404 to a known value corresponding to the user application resources. The user application resources may include IV information and the application signing certificate stored in a secure store. If the signature value is the same as the stored application signing certificate (i.e., known good value), the Kennel Agent 310 assumes that the user application file 402 on disk has not been modified by an attacker and that its permissions or privileges have not been modified. If the signature value is different than the known good value, the Kernel Agent 310 assumes that the user application file 402 has been modified and can no longer be trusted to perform the functionality that it was intended to perform.

The IV result is sent back to the kernel 306 via the LSM 312 (e.g., “OK” if the IV verification is successful) (step 4 of FIG. 4A). In response to receiving the confirmation of the IV (“OK”), the kernel 306 will perform the actions associated with the “process create” system call (step 5 of FIG. 4A) so that the new user application process 406, which is empty, is created in user-space 400 (step 6 of FIG. 4A).

The user application contents are relocated into Virtual Memory Areas (VMAs) allocated by the kernel for use by the user application process 406. To relocate the contents, the executable loader 410 processes the executable file as shown in FIG. 4B. For example when loading Executable and Linking Format (ELF) executables, the ELF loader 410 is executable code configured to process ELF disk images of the user application 402, create one or more VMAs (e.g., 408-1, 408-2, . . . of FIG. 4B) in the user application process 406 and relocate executable code contained in the ELF text section to VMAs. Here all executable code loaded by the ELF loader 410 is in the form of VMAs.

The relocated contents are typically branch-target addresses and thus affect control-flow of the application process, resulting in possibly becoming attack targets. The Kernel Agent 310 conducts the in-memory IV verification of the VMA(s) as shown in FIG. 4B, which will skip relocations. The Kernel Agent 310 may sign the VMA(s) including the relocations.

In the case that the IV verification is successful, restoration of a missing code and/or data (or “MP”) is granted. The Kernel Agent 310 binds the user application process 406 to the Kernel Agent (and the SW TEE) 310 by restoring a missing piece of code and/or data (or “MP”) 420 of the original user application executable, in the user application process 406 memory, as shown in FIG. 4C. The piece of code and/or data 420 is, for example, the code and/or data 210 of FIG. 2A that has been extracted, corrupted and/or encrypted in the user application provisioning step.

The Kernel Agent 310 injects the MP 420 at the appropriate location in the VMA(s). In a non-limiting example, a dummy value(s) used in the user application provisioning process (200A of FIG. 2A) is replaced with the corresponding original code and/or data (210 of FIG. 2A). In a non-limiting example, a piece of code and/data corrupted and/or encrypted in the user application provisioning process (200A of FIG. 2A) is restored. In the case that the MP 420 is a piece of code, the restoration of the piece of code changes the signature of the VM contents. Therefore the Kernel Agent 310 re-signs contents relocated in the VMAs to obtain a full new signature of the entire VMA contents, as shown in FIG. 4B. The Kernel Agent 310 subsequently performs incremental/ongoing in-memory IV of the entire VMA contents for further verification when the process is invoked.

By completing the IV of VMAs and restoring the missing piece of code and/or data 420 into the user application process 406 memory, the user application process 406 is fully verified and trusted and able to operate as originally intended (in contrast, if the IV verification fails at any stage, the Missing Piece code and/or data will not be provided by the KA, and the application process will not operate as originally intended). The resultant user application module 406 performs the functionality that the original version of the user application (e.g., 202 of FIG. 2A) was intended to perform, but is now bound to the Kernel Agent 310, and its successful validation of the user application's executable image. By re-signing and verifying the contents of the VMAs, it is possible to detect any change made to the relocated contents.

To accept or deny the call to create the user-space process, the Kernel Agent 310 may add further criteria including, for example, but not limited to, system/application integrity, application permissions, application behavior, security context for other applications that may be running and remote commands.

Referring to FIG. 5, there is illustrated one example of a security platform 500 in which Process State Verification is implemented. The base layer of the platform 500 includes, for example, system on a chip (SOC) 502 components including a central processing unit (CPU) 504 and memory (read only memory (ROM)) 506 within which the basic input/output system (BIOS) 408 and digital certificate 510 reside. The highest layer in the platform 400 is a device application layer including one or more user applications 520a, 520b, each having a signature 522 if appropriate. Intervening layers include an open source OS 525, a OS kernel 430, a secure store 532 for a Kernel Agent 534, a system call interface 536, a hard disk drive (HDD) storage device or flash memory 540, and a boot loader 550.

The Kernel Agent 534 maintains and has sole access to the secured data store 532 within which the Kernel Agent 534 keeps information relevant for the Kernel Agent's performance of kernel resource access control, Integrity Verification, application licensing and application resource access control. While the secure store 532 is shown in FIG. 5 as being a separate component, the secure store 532 exists within the hard drive or flash 540. The secure store 532 may exist as a secure memory area within the system on a chip base layer 502.

The Kernel Agent 534 is Linux Security Module interface (LSM I/F) compliant. The Kernel Agent 534 forms an integral and un-detachable part of the OS kernel 530 without which the kernel based OS and/or the applications 520a, 520b will cease to function correctly. In order to render the Kernel Agent 534 resistant to tampering, modification, and reverse engineering attacks, the Kernel Agent 534 may be protected using software protection techniques such as, but not limited to, those described in more detail in U.S. Pat. Nos. 6,594,761, 6,779,114, 6,842,862, and 7,506,177 each issued to Chow et al.

One example of the functions of the Kernel Agent 534 is to monitor the integrity of both the kernel based OS and the user applications 520a, 520b loaded onto the platform 500, and to detect any breaches of the OS 530, secure boot 550 and the user applications 520a, 520b. The IV may be conducted as shown in FIGS. 3B and 4B. Another example of the functions of the Kernel Agent 534 is to inject a piece of code and/or data (“MP” 420 of FIG. 4C) missing in the user application executable (on-disk) into a user application process's executable memory if it is signed/validated.

A further example of the functions of the Kernel Agent 534 may include controlling application access to OS kernel resources and data where the access control decisions may be made by the Kernel Agent based on, but not limited to, factors such as: OS kernel integrity, application integrity, application context, and the privileges granted by any given trusted root authority. An access control decision based on OS kernel integrity determines whether the kernel has been modified, been replaced, been added to, or had portions removed in an unauthorized manner. The access control decision may also determine whether the secure boot process completed in successfully (i.e. without tampering). If the OS kernel has been modified, replaced, added to or portions removed or the secure boot process cannot be positively verified, this determination would serve to invalidate many of the assumptions that the Kernel Agent or an application or a secure application such as a media player would normally operate under. An access control decision based upon application integrity determines whether the application that is attempting to access OS kernel resources has been modified in any way (e.g., to insert malware into the application or by other malware) or whether the privileges associated with that application been modified (e.g., to give it privileges to access system resources that were not authorized by the certifying authority).

Each element in the embodiments of the present disclosure may be implemented as hardware (e.g., general and/or specialized computer processor), software/program in a carrier, or any combination thereof. Software codes, either in its entirety or a part thereof, may be stored in a computer readable medium (e.g., as a ROM, for example a CD ROM or a semiconductor ROM, or a magnetic recording medium, for example a floppy disc or hard disk), and may be executed by a computer processor. The program may be in the form of source code, object code, a code intermediate source and object code such as partially compiled form, or in any other form. A computer data signal representing the software code which may be embedded in a carrier wave may be transmitted via a communication network. The carrier may be any entity or device capable of carrying the program. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

One or more currently preferred embodiments have been described by way of example. It will be apparent to persons skilled in the art that a number of variations and modifications can be made without departing from the scope of the invention as defined in the claims.

1. A method of enhancing security on a computing device, comprising:
verifying integrity of operating system code on the computing device to establish a trusted execution environment in the operating system of the computing device; and
in response to the successful integrity verification of the operating system code, binding a user-space application on the computing device to the operating system on the computing device.

2. A method according to claim 1, wherein the verifying integrity of the operating system code comprises:
verifying integrity of on-disk and/or in-memory image of the operating system,
the method comprising granting the binding of the user-space application and the operating system in response to success of the integrity verification of the on-disk and/or in-memory image of the operating system.

3. A method according to claim 2, wherein the verifying integrity of the operating system code comprises:
in response to success of the integrity verification of the on-disk and/or in-memory image of the operating system, verifying continuous and incremental integrity of the in-memory image of the operation system,
the binding of the user-space application and the operating system being granted in response to success of the continuous and incremental integrity verification of the on-disk and in-memory image of the operating system.

4. A method according to claim 1, comprising:
in response to success of the integrity verification of the operating system code, verifying integrity of the user-space application to establish a trusted execution environment in the user-space application, and
granting the binding of the user-space application and the operating system in response to success of the integrity verification of the user-space application.

5. A method according to claim 4, wherein the verifying integrity of the user-space application comprises:
verifying integrity of an on-disk image of the user-space application,
the binding of the user-space application and the operating system being granted in response to success of the integrity verification of the on-disk image of the user-space application.

6. A method according to claim 4, wherein the verifying integrity of the user-space application comprises:
verifying integrity of an on-disk image of the user-space application, and
in response to success of the integrity verification of the on-disk image of the user space application, verifying integrity of an in-memory image of the user-space application,
the binding of the user-space application and the operating system being granted in response to success of the integrity verification of the in-memory image of the user-space application.

7. A method according to claim 6, comprising:
after binding the user-space application to the operating system, performing continuous and incremental integrity verification of the in-memory image of the user-space application.

8. A method according to claim 7, comprising:
upon failure of the continuous and incremental integrity verification of the in-memory image of the user-space application, removing the binding between the user-space application and the operating system.

9. A method according to claim 6, comprising:
after binding the user-space application to the operating system, re-signing the in-memory image of the user-application.

10. A method according to claim 9, comprising:
after re-signing the in-memory image of the user-application, verifying integrity of the in-memory image of the user-application.

11. A method according to claim 4, wherein the verifying integrity of the user-space application comprises:
verifying integrity of an on-disk image of the user-space application, and
in response to success of the integrity verification of the on-disk image of the user space application, verifying integrity of an in-memory image of the user-space application, the method comprising:
signing the in-memory image of the user-space application prior to the binding of the user-space application and the operating system.

12. A method according to claim 11, comprising performing continuous and incremental integrity verification of the in-memory image of the user-space application,
wherein the binding of the user-space application and the operating system is granted in response to success of the continuous and incremental integrity verification of the in-memory image of the user-space application.

13. A method according to claim 11, comprising locating contents of the on-disk user application into a memory by a loader, wherein the verifying integrity of an in-memory image of the user-space application comprises verifying integrity of the in-memory image of the user-space application except relocations of the loader, and wherein the signing the in-memory image of the user-space application comprises signing the in-memory image of the user-space application including the relocations.

14. A method according to claim 4, wherein the verifying integrity of the user-space application comprises:
verifying integrity of an on-disk image of the user-space application, and
in response to success of the integrity verification of the on-disk image of the user space application, verifying integrity of an in-memory image of the user-space application, the method comprising:
signing the in-memory image of the user-space application prior to the binding of the user-space application and the operating system,
the binding of the user-space application to the operation system being implemented if the integrity verification is successful.

15. A method according to claim 14, wherein:
in response to the binding of the user-space application and the operating system, re-signing the in-memory image of the user-space application.

16. A method according to claim 15, comprising:
in response to re-signing the in-memory image of the user-space application, performing continuous and incremental integrity verification of the in-memory image of the user-space application.

17. A method according to claim 14, comprising locating contents of the on-disk user application into a memory by a loader, wherein the verifying integrity of an in- memory image of the user-space application comprises verifying integrity of the in-memory image of the user-space application except relocations of the loader, and wherein the signing the in-memory image of the user-space application comprises signing the in-memory image of the user-space application including the relocations.

18. A method according to claim 1, comprising:
granting one or more privileges to the user application in connection with the computing device's resource, in response to the success of all integrity verification.

19. A method according to claim 18, comprising:
revoking any privilege allocated to the user application upon failure of any integrity verification.

20. A method according to claim 1, wherein the binding a user-space application to the operating system comprises:
restoring a piece of code and/or data of an original version of a corresponding user application file, in a memory allocated to the user-space application by using the operating system, to perform a functionality of the original version of the user application file.

21. A method according to claim 20, wherein the restoring a piece of code and/or data comprises:
injecting the piece of code and/or data of the original version of the user application file, into the memory by using the operating system.

22. A method according to claim 20, wherein the restoring a portion of code and/or data comprises:
recovering the piece of code and/or data extracted from the original version of the user application file; and/or
uncorrupting and/or decrypting code and/or data to restore the piece of code and/or data of the original version of the user application.

23. A system for enhancing security on a computing device, comprising:
a processor configured for:
verifying integrity of operating system code on the computing device to establish a trusted execution environment in the operating system of the computing device; and
in response to the successful integrity verification of the operating system code, binding a user-space application on the computing device to the operating system on the computing device.

24. (canceled)

25. A computer readable storage medium storing computer readable instructions which, when executed by a computer processer in a mobile device, cause the processor to:
verify integrity of operating system code on the computing device to establish a trusted execution environment in the operating system of the computing device; and
in response to the successful integrity verification of the operating system code, bind a user-space application on the computing device to the operating system on the computing device.
